(19) United States
(12) Patent Application Publication
(10) Pub. No.: US 2004/0169641 A1
(43) Pub. Date: Sep. 2, 2004

(54) Method and apparatus for inputting data

(76) Inventors: James J. Bean, Loveland, CO (US); Erin Francom, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/375,954

(22) Filed: Feb. 28, 2003

(51) Int. Cl. G09G 5/00

(52) U.S. Cl. 345/168

(57) ABSTRACT

A data input apparatus for use with data processing devices is disclosed. The apparatus includes a keyboard base having a plurality of switches, a keyframe, and a plurality of keys arranged on the keyframe. The keyframe mates with the keyboard base, which has circuitry for generating character data associated with the plurality of keys. Moreover, upon mating, the keyframe can engage one or more of the plurality of switches to be uniquely identified according to the arrangement of the plurality of keys on the keyframe.

### BACKGROUND OF THE INVENTION

Most computer systems receive a majority of their data input via user manipulation of a peripheral device such as a standard computer keyboard. The standard computer keyboard is sometimes referred to as the QWERTY keyboard, derived from the letter layout of the left hand side second horizontal row, and consists in diagrammatic representation of four horizontal rows of alphanumeric keys. The keys on one horizontal row are offset with respect to the keys on adjacent horizontal rows so that diagonal columns are formed.

The QWERTY keyboard has long been recognized to have many disadvantages. The QWERTY layout was originally designed for mechanical typesetting devices, and in particular to minimize any possibility of jamming of the arm members of the mechanical typesetting devices. One problem with this type of keyboard arrangement, however, is that the keyboard is anti-ergonomic which limits a user's ability to use the keyboard for extended periods of time.

Another shortcoming of the standard computer keyboard is the lack of support and standardization for the entry of specialized data (e.g., scientific nomenclature and foreign language symbols). Current methods of entering scientific and other specialized data include using key-combination sequences in conjunction with software. These key-combinations are not standardized between software packages requiring the user to memorize and recall the proper sequence for each software application. Chording is the common term used to describe striking several keys simultaneously and requires some amount of dexterity on the part of a user, limiting the usefulness of the standard keyboard to many users such as children, elderly, arthritic, and handicapped users.

Many prior art keyboard arrangements have been proposed to eliminate the inadequacies of the “QWERTY” keyboard. These solutions tend to focus on operator performance characteristics related to alphanumeric data entry, e.g., DVORAK alphanumeric key layouts, and do not solve the problem of single keystroke entry of specialized data, such as commonly used object-orientated data. Such systems incorporate letter layout alternatives or geometric alternatives, or a combination of both, for an improved keyboard arrangement.

Other prior art keyboard key arrangements have been successful in enabling single keystroke identification and data input of object-specific symbols with operator pre-programming of specific function and/or control keys to use in conjunction with alphanumeric characters for each particular software product. The process of pre-programming keys has its disadvantages, since software products have different methods of pre-programming keys. Furthermore, the arrangement of the pre-programmed keys can be quickly forgotten by the user since the keys are commonly pre-programmed as a combination of two or more keys that are not identified in the keyboard layout. Another drawback of pre-programming keys in a particular configuration is that the pre-programmed key arrangement is device specific, and not readily transferable to another data entry device.

### SUMMARY

An apparatus for providing improved data entry into a data processing device is described. One embodiment of the data input apparatus comprises a keyboard base having a set of switches and a keyframe configured to mate with the keyboard base. The keyframe is configured to engage one or more of the switches to identify the keyframe upon the mating of the keyframe to the keyboard base. A plurality of keys are disposed within the keyframe and can be pressed or actuated by a user to generate character data transmitted by circuitry associated with the keyboard base. Each keyframe may have the same key configuration, but at least some of the characters or symbols generated, when corresponding keys of different keyframes are activated, are different.

### DESCRIPTION OF THE DRAWINGS

FIG. 1 is a perspective view of one embodiment of a data processing system having a data input apparatus;

FIG. 2 is a block diagram of control circuitry for the data processing system of FIG. 1;

FIG. 3A is an exploded view of another embodiment of a data input apparatus;

FIG. 3B is an exploded view of another embodiment of a data input apparatus having opto-electronic sensor switches;

FIG. 4 is one embodiment of a keyframe illustrating an object-orientated arrangement of a plurality of keys; and

FIG. 5 is an alternative embodiment of a keyframe.

### DETAILED DESCRIPTION

A keyboard-type apparatus capable of permitting single keystroke entry of object-orientated symbols for selected target groups is set forth, which provides for single keystroke entry of object-orientated symbols and enables users to rapidly and efficiently create and edit many types of documents. One advantage of the apparatus is that keystroke entry is intuitive since the keys are identified. Additionally, users have more accuracy and less fatigue with a single keystroke-type of apparatus since the number of keystrokes required to input object orientated symbols is significantly reduced. Another advantage of the apparatus is that layouts of the keys can be readily manipulated to be visually stimulating to a specific user or target group. For example, a wide variety of custom colors and motifs can be provided.

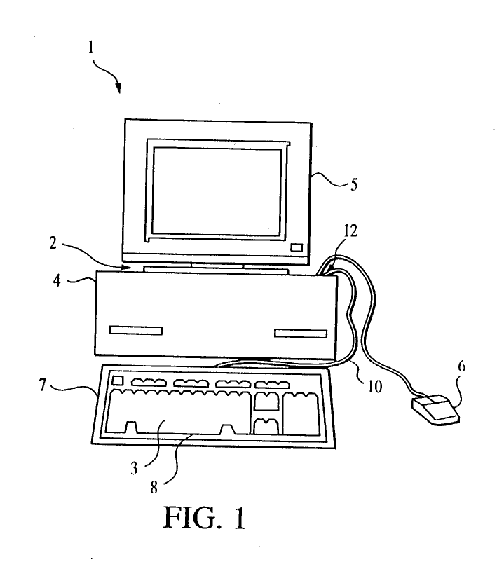

Turning now to the drawings, FIG. 1 is one embodiment of a data processing system 1 which includes a computer 2 having a data input apparatus 3. The data input apparatus 3 is provided with a pre-determined set of selections based on a desired target group, and is designed for entering data into a central processing and memory unit 4 (hereinafter CPU) that commonly connects to other peripheral devices. These other peripheral devices may include a monitor 5 for displaying output or object-orientated symbols sent from the CPU 4, and an input device such as a mouse 6. The data input apparatus 3 is formed as a keyboard like structure, and includes a keyboard base 7 and a keyframe 8. The keyframe 8 is mateable with the keyboard base 7, and can be fastened to the keyboard base in a variety of methods known to those skilled in the art. The keyboard base 7 is in communication with the computer 2, such as via a transmission line 10, which feeds into the data input apparatus 3. That is, the data input apparatus 3 can connect to the CPU 4 using standard keyboard type connection means, with the data input apparatus 3 directly attached to the CPU via an interface 12 of the computer 2. In this type of arrangement, the data input apparatus 3 is configured to allow single keystroke entry of data input or object-orientated signals to the CPU 4. These signals can then be processed by the CPU 4 to generate object-orientated symbols on the display 5.

In general, a keyboard has several components. These components include a plurality of keys, a keyboard structure which maintains the keys in a pre-arranged position relative to one another and may provide some support against flexure of the keyboard, and a switch assembly for detecting when a key is being pressed or actuated. The keyboard also has a way of communicating this detection to the CPU of the data processing system or computer. Furthermore, the arrangement of keys within the keyboard structure is designed to place the keyboard at a comfortable position to facilitate data input by a user.

There are also multiple methods of integrating keys, keyboard structures, and the switch assembly together for communicating with an CPU, as those familiar with the art will understand, and the illustrations described herein should not be deemed to be a limitation in how the principle disclosed can be applied to a wide variety of keyframe designs that use a multitude of keys having various shapes, sizes, and/or orientations on the keyboard base.

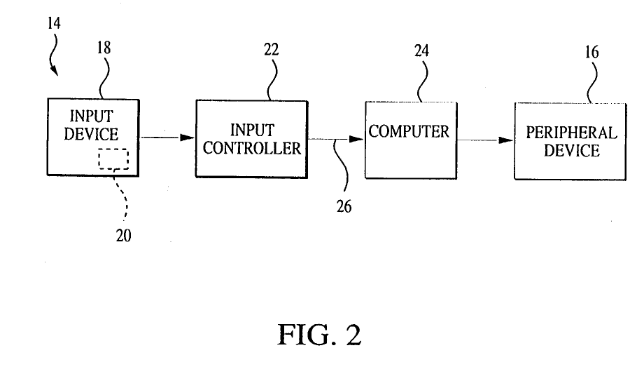

Referring now to FIG. 2, the overall configuration of a control circuit 14 that controls a peripheral device 16 is shown and includes an input device 18, which may include a keyframe connected to a keyboard base as discussed herein, that has a processor 20 (shown in dashed lines) associated therewith. Data and control inputs generated by the input device 18 are transmitted to an input controller 22 in electrical communication therewith. Typically, the inputs transmitted to the input controller 22 include data and/or control inputs for use by a computer 24 as well as control inputs for controlling the peripheral device 16. The input controller 22 is provided with programmable code that is configured to read certain ones of the inputs generated by the input device 18 and transmit these inputs to the computer 24 via a bus 26. The computer 24 may propagate control signals to the peripheral device 16, or alternatively, generate control signals for transmission to the peripheral device. By way of example, if the peripheral device 16 is a monitor, the computer 24 can transmit a signal associated with an input of data from the input device 18 to cause character data to be displayed on the monitor.

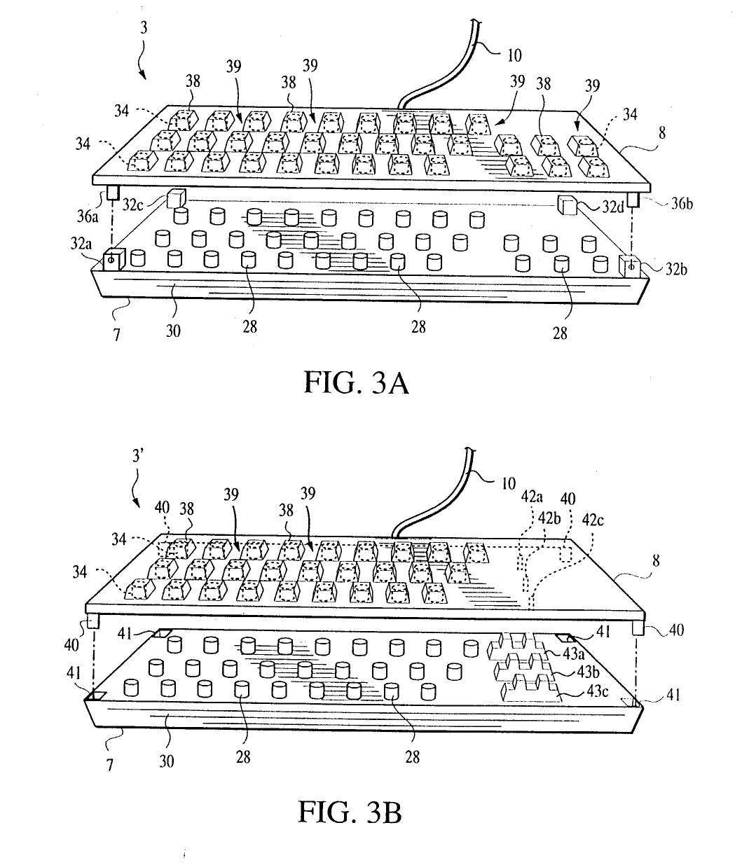

Referring now to FIG. 3A, an exploded view of the data input apparatus 3 is shown. The keyboard base 7 includes a matrix of switches 28 that are interconnected by circuitry 30, which can include processors and other electrical components that transmit signals via line 10 upon actuation of the switches as is known to those skilled in the art. In particular, the circuitry 30 connects to one or more identifier switches, such as switches 32a, 32b, 32c and 32d. These identifier switches can be integrated with the matrix of switches 28, or alternatively isolated as a separate circuit housed in the keyboard base 7. The identifier switches 32a, 32b, 32c and 32d can be positioned at various locations on the keyboard base 7, and may be optical, electrical, or electromechanical switches.

In the embodiment shown in FIG. 3A, four identifier switches 32a, 32b, 32c and 32d are provided for use in identifying the keyframe 8, and in particular a layout or arrangement of a plurality of actuating members 34 (shown in dashed lines) of the keyframe. Using these four identifier switches 32a, 32b, 32c and 32d, sixteen different keyframes can be identified by selecting one or more of the identifier switches. For example, selection of one particular keyframe 8 may occur by attaching two tabs or extending members 36a and 36b to the keyframe to engage identifier switches 32a and 32b. Other keyframes can be identified by having tabs to select different switch combinations, such as switches 32a and 32b, 32c and 32d, or by including a different number of tabs. By uniquely selecting specific combinations of tabs for each keyframe to engage identifier switches, a processing system such as the computer 11 of FIG. 1 can sense a context of the keyframe layout. The circuitry 30 processes this context information upon engagement of the tabs with the identifier switches, which generates one or more signals that uniquely identify each keyframe 8, and provides such information to the computer 2.

A plurality of key caps 38 overlay the actuating members 34 to define keyboard keys 39, and provide identification to a user of the data entered by actuation of a key and its' underlying switch 28. In particular, the structure of the keyframe 7 accommodates a positioning or arrangement of the keys 39 within the keyframe. One or more of the plurality of key caps 38 identify symbols and overlay actuating members 34 that are configured to generate character data and symbol signals to a CPU upon single keystroke actuation of the key caps and respective actuating members. Furthermore, the key caps 38 are preferably removable from the keyframe 8, and can be interchanged with other key caps identifying other characters and/or symbols, if desired. In alternate arrangements, the key caps 38 can be integrated into the keyframe 8.

The data input apparatus 3 is configured to provide single keystroke data input of character data, object-orientated symbols, etc. via a transmission means such as line 10 to a central processing unit, for example, the CPU 4 shown in FIG. 1. Preferably, the character set for a specific data input apparatus 3 is selected for a specific target group, such as scientists. In alternative embodiments of the data input apparatus 3, the number of identifier switches 32a, 32b, 32c and 32d, and location of the identifier switches and the extending members 36a and 36b on the keyframe 8 can vary to facilitate keyframe identification. By way of example, the use of five identifier switches would enable 32 keyframe combinations. In addition, other methods of keyframe identification, such as adding photodiodes or other types of optical switches to the circuitry 30 of the keyboard base 7, or as a stand alone circuit, can be implemented.

There are many advantages to providing a removable keyframe that has an arrangement of keys that can be sensed by a keyboard base, and ultimately a CPU of a computer or other processing device. For example, it is economically advantageous in the manufacturing process to form keyboard structures having common keyboard bases and multiple keyframes rather than specialized keyboards. That is, users desiring multiple interfaces need not purchase multiple keyboard bases, and can interchange keyframes with a single keyboard base. Moreover, the keyframes are more readily portable than keyboards allowing users to transport keyframes to other locations having data processing systems.

FIG. 3B illustrates an alternative embodiment keyframe 3′, and has like parts identified with identical reference numerals. The keyframe 3′ has support extensions 40 for securing the keyframe to the base 7. The support extensions 40 are preferably sized to provide a friction fit with receiving openings 41 located in the base 7. The keyframe may include one or more elongated members or tabs, such as tabs 42a, 42b and 42c, which when each is present, is preferably positioned to operate together with opto-electronic sensor switches, such as switches 43a, 43b and 43c positioned in the base 7 as illustrated. More particularly, the sensor switches 43a, 43b and 43c each preferably have transmitters and receivers that respectively transmit and detect optical energy, i.e., light signals. Such sensor switches may have a transmitter located on one side of a gap or space and a receiver located on the other side of the space. If a tab were present in the gap or space, it would block the light path, i.e., it would keep the receiver from detecting the transmitted light energy and would therefore generate a different signal than if the light energy were detected. The sensor switches may also be designed to have the transmitter and receiver on the same side of a space or gap and a reflecting surface on the opposite side, so that the presence of a tab in the gap or space would similarly result in a different signal than if it were not blocking the light circuit.

The opto-electronic sensor switches are adapted to provide selective signals to the CPU 4 of FIG. 1 depending upon whether optical energy is detected by the receivers. One or more of the tabs 42a, 42b or 42c may be provided depending upon the identification of the particular keyframe. Keyframes with different functionality will have different combinations of one or more tabs. With the base having three sensor switches, the different combinations of tabs that can interact with the sensor switches can identify eight different keyframes. In a similar manner, additional tabs and corresponding opto-electronic sensors can allow more keyframes to be identified.

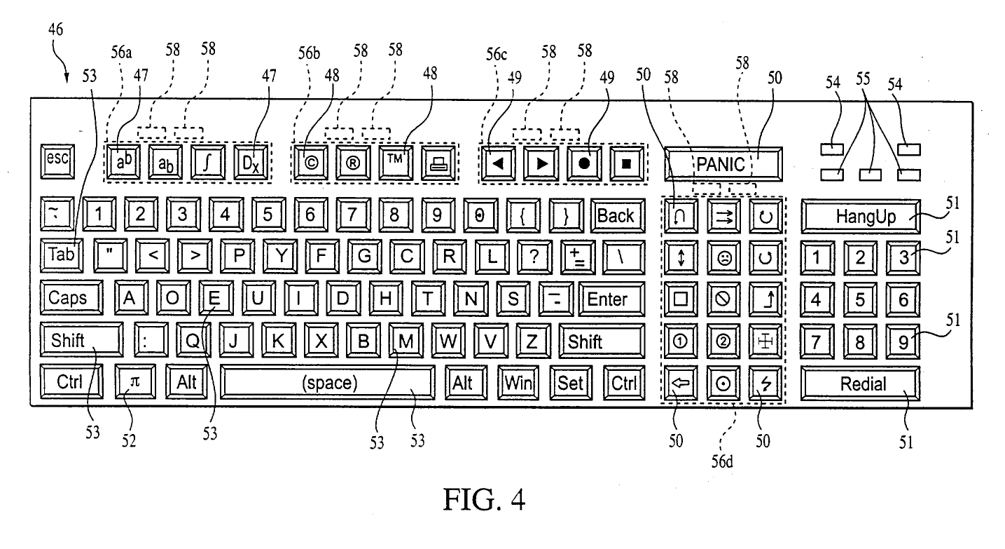

Referring now to FIG. 4, a top plan view of a preferred embodiment keyframe 46 is shown. The keyframe 46 includes a plurality of customized or selected keys for single keystroke entry of object-orientated symbols or character data for specific target groups. These customized keys include mathematical keys 47, business keys 48, multimedia keys 49, manufacturing and industry keys 50, telecommunication keys 51, and a π key 52. Additional keys 53 common to a DVORAK style key layout are also included. Windows 54 maybe used for other identifying purposes, such as locked capital letters of the DVORAK keys 53, as is known to those skilled in the art. Tabs 55 may be used to identify the keyframe 46 in cooperation with opto-electronic sensor switches, such as sensor switches 43a, 43b and 43c of FIG. 3B.

One feature of the present embodiment of the keyframe 46 is that the keyframe can be segmented into one or more removeable key set portions 56a, 56b, 56c and 56d (shown in phantom) which can be removed from the keyframe and replaced with another portion having a new key arrangement. The portions 56a, 56b, 56c and 56d can be configured to have tab members (not shown) associated with the respective portions that interact with opto-electronic sensor switches 58 to identify the portions and transmit signals to a CPU identifying the replaced portions. Although two opto-electronic sensor switches 58 are shown for each of the portions 56a, 56b, 56c and 56d, additional opto-electronic or other sensor switches may be included to provide additional selections for replacement of the portions. Moreover, it is contemplated that any set of keys or portion of the keyframe 46 may be segmented and have elongated members or tabs associated therewith to enable replacement of that portion.

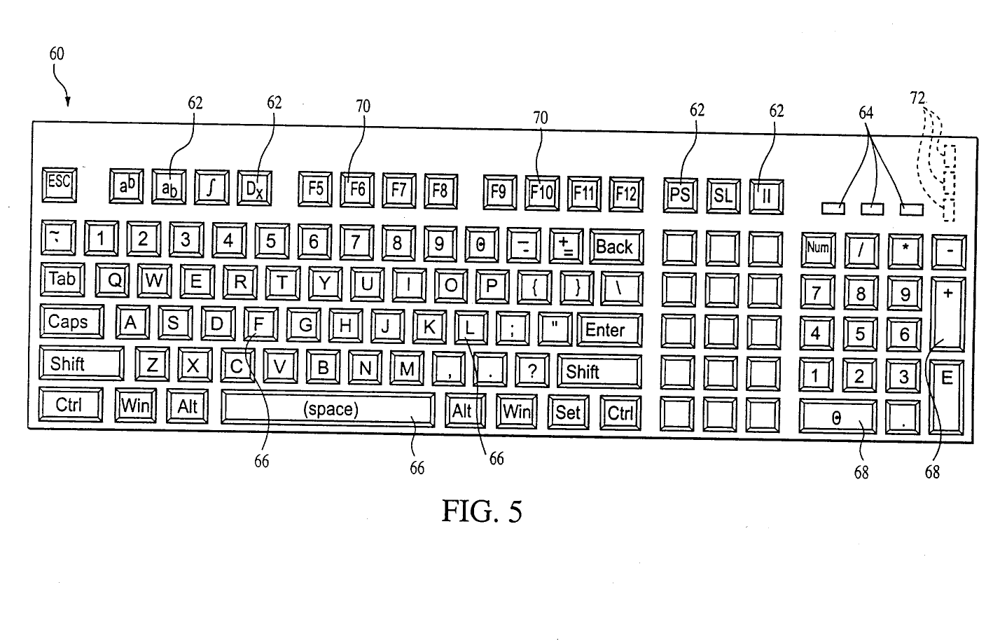

FIG. 5 illustrates an alternative embodiment keyframe 60 that again includes a plurality of targeted keys 62 and windows 64 for identifying locked capital letters and the like. The keyframe also includes QWERTY keys 66, which include numerical keys 68 and function keys 70. The key and actuating member arrangement of this keyframe 60, by way of design, is targeted for mathematical users. In particular, the keyframe 60 enables single keystroke entry of mathematical object orientated symbols such as integrals, exponents, etc. The keyframe 60 also includes four tabs 72 (shown in phantom) that may enable opto-electronic sensor switches positioned in a keyboard base, similar to the sensors 43a, 43b and 43c of FIG. 3B, to identify the keyframe 60 and transmit one or more signals to a CPU that uniquely identify the keyframe 60. In this manner, the arrangement of tabs can be used to uniquely define keyframes for a variety of arrangements of the keys of the keyframes. In alternative embodiments, the keyframe 60 could have elongated members that engage electrical or electromechanical switches of the keyboard base, with the position and/or number of the elongated members uniquely identifying each of the keyframes.

The computer 2 includes associated software programs for mapping user-specific keys to the matrix of switches 28, the context of which is defined by the unique actuating pattern of the identifying switches, e.g., 32a, 32b, 32c and 32d, for each respective keyframe and a specific configuration file. Moreover, such associated software programs can further determine the context of a software application in use and map user key combinations such that specialized characters, such as the symbol π, can be displayed as a symbol or a numerical value according to a particular software package. The actuating members 34 preferably interact with the matrix of switches 28 to enable single keystroke entry of data upon the mating of the keyframe 8 via one or more extending members, such as extending members 36a and 36b, which actuate a specific combination of identifier switches to transmit a signal identifying the keyframe 8.

It will be appreciated that the selection of the individual target group keys, e.g., the mathematical keys 42 of FIG. 4, as well as the overall general selection of whether to include actuating members and keys directed to business, scientific, multimedia, and any other specific target groups on any given keyframe arrangement can vary greatly. Selection of particular combinations can be determined according to specific target groups, with keyframes for each target group identified by the unique actuation of identifier switches upon the mating of the keyframe to a keyboard base. By way of example, a keyframe could be targeted for toddlers, and include alphabet and number keys, including larger keys, colored keys, and a limited number of object orientated character keys that can be generated by single keystrokes of the keys disposed within the keyframe. Moreover, it is envisioned that the keyframe can have a QWERTY type arrangement of keys or the like replaced with larger colored keys for use with children and/or handicapped individuals. In addition, the keyframes could be made with Braille markings, and formed of various textured materials including, but not limited to, flocked, rubberized, plastic materials, etc.

It will also be appreciated that the term “computers” as used herein is intended to broadly refer to processor-based devices capable of executing computer readable instructions. A “computer” as used herein is thereby not limited to desktop computers, but includes laptop computers, mainframe computers, and other systems incorporating a CPU and a keyboard for inputting alphanumeric and object-orientated symbols.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A data input apparatus for a data processing device, comprising:
a keyboard base having a plurality of switches;
a keyframe mateable with said keyboard base, said keyframe configured to engage one or more of said plurality of switches to uniquely identify said keyframe;
a plurality of keys disposed within said keyframe; and,
circuitry associated with said keyboard base for generating character data associated with respective ones of said plurality of keys.

2. The data input apparatus of claim 1 wherein said keyframe includes actuating members associated with said plurality of keys.

3. The data input apparatus of claim 2 further comprising a means for determining an arrangement of said plurality of keys on said keyframe.

4. The data input apparatus of claim 3 wherein said circuitry associated with said keyboard base includes identifier switches engaged by said keyframe to determine said arrangement of said plurality of keys.

5. The data input apparatus of claim 1 wherein actuation of said identifier switches generates a signal unique to said keyframe.

6. The data input apparatus of claim 4 wherein said keyframe includes at least one extending member for contacting said identifier switches upon mating of said keyframe to said keyboard base.

7. The data input apparatus of claim 1 wherein said keyframe enables single keystroke entry of one of business symbols, multimedia symbols, mathematical symbols, and manufacturing symbols.

8. Apparatus for inputting object-orientated data to a computer, comprising:
a plurality of keys;
a keyboard base;
a keyframe connectable to said keyboard base and identifiable by the computer, and wherein said keyframe is configured to accommodate said plurality of keys; and,
circuitry in said keyboard base having switches actuateable by said plurality of keys and said keyframe for generating and transmitting data specifying an arrangement of said plurality of keys and a key character to the computer upon actuation of one of said plurality of keys.

9. The apparatus of claim 8 wherein said plurality of keys are integrated into said keyframe.

10. The apparatus of claim 8 wherein one or more of said plurality of keys are symbol keys, each of said symbol keys configured to generate a symbol signal representative of a respective symbol key to a CPU upon single keystroke actuation of said respective symbol key.

11. The apparatus of claim 8 wherein one or more of said plurality of keys are function keys, each of said function keys being configured to generate a signal representative of a respective function key to a CPU upon single keystroke actuation of said respective function key.

12. The apparatus of claim 10 wherein said circuitry comprises a plurality of interconnected switches having a switch for each of said symbol keys.

13. The apparatus of claim 8 wherein said circuitry includes one or more opto-electronic switches for identifying said keyframe.

14. The apparatus of claim 8 wherein said keyframe includes one or more extending members for engaging one or more of said switches of said circuitry.

15. The apparatus of claim 14 wherein said arrangement of said plurality of keys is identifiable by a number of said one or more extending members on said keyframe.

16. An apparatus for use with a keyboard base of a computer, the keyboard base having a matrix of switches engageable with a plurality of keys, the apparatus comprising:
a keyframe configured to accommodate the plurality of keys; and,
wherein said keyframe includes a means for transmitting one or more keyframe identifier signals to the computer upon a mating of said keyframe to the keyboard base.

17. The apparatus of claim 16 wherein said means for transmitting one or more keyframe identifier signals to the computer comprises one or more extending members connected to said keyframe and configured to engage one or more switches of the matrix of switches upon said mating of said keyframe to the keyboard base.

18. The apparatus of claim 16 wherein said keyframe includes actuating members for engaging the plurality of keys.

19. The apparatus of claim 16 wherein said keyframe enables single keystroke entry of one of business symbols, multimedia symbols, mathematical symbols, and manufacturing symbols.

20. A computer system comprising:
a CPU;
a display unit connected to said CPU for displaying symbols; and,
a keyboard having circuitry associated therewith to communicate with said CPU, said keyboard further comprising:
a plurality of keys;
a keyboard base having one or more switches actuatable by said plurality of keys; and,
a keyframe mateable with said keyboard base, wherein a mating of said keyframe to said keyboard base causes one or more signals to be transmitted to said CPU identifying an arrangement of said plurality of keys on said keyframe.

21. The computer system of claim 20 wherein said keyframe includes actuating members for engaging said plurality of keys.

22. The computer system of claim 20 wherein said keyframe includes one or more opto-electronic sensor switches configured for transmitting optical energy from a transmitter to a receiver of each of said opto-electronic sensor switches.

23. The computer system of claim 22 wherein at least one elongated member is connected to said keyframe and prevents passage of said optical energy between said transmitter and said receiver upon a mating of said keyframe to said keyboard base.

24. A data input apparatus for a data processing device, comprising:
means for arranging a plurality of keys for generating character data;
means for identifying said means for arranging; and
means for transmitting signals based on said means for identifying to a CPU to generate said character data associated with said means for arranging; and
means for connecting said means for transmitting, said means for identifying, and said means for arranging to each other.

25. The apparatus of claim 24 wherein said means for arranging a plurality of keys comprises a keyframe connectable to a keyboard base.

26. The apparatus of claim 24 wherein said means for identifying said means for arranging comprises a plurality of identifier switches.

27. The apparatus of claim 26 wherein said means for transmitting signals comprises circuitry associated with a keyboard base for generating said character data associated with said means for arranging.

28. The apparatus of claim 20 wherein said keyframe includes one or more removeable key set portions.

29. The apparatus of claim 28 wherein said removeable key set portions have one or more elongated members associated therewith.

30. A method of entering data into a CPU for one of multiple target groups, the method comprising the steps of:
A) arranging a plurality of keys on separate keyframes for each of the multiple target groups;
B) selecting a target group having an associated keyframe;
C) connecting said associated keyframe to a keyboard base; and
D) actuating keys on said associated keyframe to transmit signals to said CPU.

31. A method of reconfiguring a keyboard for multiple target groups, the keyboard having a keyboard base to which any one of at least first and second keyframes may be connected, the method comprising the steps of:
arranging a plurality of keys on respective first and second keyframes for two of the multiple target groups;
connecting a first keyframe associated with a first and second target group to the keyboard base, wherein the keyboard base identifies said first keyframe and enables data transmission therefrom; and
replacing said first keyframe with a second keyframe associated with a second target group, wherein said keyboard base identifies said second keyframe and enables data transmission therefrom.
